(19) United States
(12) Patent Application Publication
(10) Pub. No.: US 2026/0369916 A1
(43) Pub. Date: Nov. 19, 2026

(54) NETWORKING CABLE CONNECTOR STRUCTURE

(71) Applicant: T3 INDUSTRIAL CO., LTD., Taipei City (TW)

(72) Inventor: CHUNG-TSER WU, Taipei City (TW)

(73) Assignee: T3 INDUSTRIAL CO., LTD., Taipei City (TW)

(21) Appl. No.: 19/365,207

(22) Filed: Oct. 22, 2025

(30) Foreign Application Priority Data
May 19, 2025 (TW) 114205046

(51) Int. Cl. H01R 13/502

(52) U.S. Cl. CPC H01R 13/502; H01R 2201/04

(57) ABSTRACT

A networking cable connector structure has two insertion holes on two sides of a front-end surface of a main body of a plug. A plurality of pin holes is provided between the insertion holes. A cable hole communicating with the pin holes is provided on a rear-end surface of the main body. A bottom side of a front-end portion of the main body has a plurality of grooves respectively communicating with the respective pin holes. A top side of the front-end portion of the main body is connected to a locking tab. A covering plate covers front ends of the pin holes. Two insertion rods are respectively connected to two sides of the covering plate. Each insertion rod has a conical portion and is inserted into one of the insertion holes, thereby fixing each insertion rod within one of the insertion holes through press-fit engagement.

### BACKGROUND OF THE INVENTION

### Technical Field

The present invention relates generally to a connector for network communication, and more particularly to a networking cable connector structure.

### Description of Related Art

When a conventional networking apparatus is required to connect to a network, an electronic device is provided with a networking cable port for inserting a connector of a networking cable. A conventional connector of a networking cable has a plurality of pin holes. After the networking cable is inserted into a rear end of the connector, wires in the networking cable are inserted into the pin holes. Afterwards, wires are electrically connected to contacts of the connector.

Upon mounting the networking cable to the conventional connector, in order to ensure that a sufficient portion of each of the wires is inserted into one of the pin holes, the wires extend frontward out of the pin holes and excessive portions of the wires extending out of the pin holes are cut by using a wire stripper. However, front ends of the wires are exposed, which might cause electric leakage or malfunction due to environmental exposure, thereby affecting the signal transmission performance of the conventional connector of the networking cable.

### BRIEF SUMMARY OF THE INVENTION

In view of the above, the primary objective of the present invention is to provide a connector structure for mounting a networking cable therein, wherein a connector is detachably engaged with a cover, and the cover protects wires of the networking cable from exposure, thereby ensuring the signal transmission performance of the networking cable disposed in the networking connector structure.

The present invention provides a networking cable connector structure including a plug and a cover. The plug includes a main body. The main body has a front-end surface and a rear-end surface. Two insertion holes are respectively provided on two sides of the front-end surface. A plurality of pin holes extending along a front-rear direction is provided at a portion of the front-end surface located between the two insertion holes. The pin holes are horizontally arranged and middle portions of any two adjacent pin holes are connected to each other. The rear-end surface has a cable hole. A front end of the cable hole communicates with rear ends of the pin holes. A front-end portion is formed at a portion of the main body adjacently connected to the front-end surface. A plurality of grooves is provided on a bottom side of the front-end portion and a number of the grooves is equal to a number of the pin holes. A top end of each of the grooves communicates with one of the pin holes. A top side of the front-end portion is connected to a locking tab.

The cover has a covering plate. A side of the covering plate facing the plug has a rear surface. Two insertion rods are respectively connected to two sides of the rear surface. Each of the insertion rods has a conical portion. A diameter of the narrowest portion of the conical portion is less than a diameter of each of the insertion holes. Each of the insertion rods is inserted into one of the insertion holes through the conical portion, so that each of the insertion rods is fixed within one of the insertion holes through press-fit engagement. The covering plate covers front ends of the pin holes.

With the aforementioned design, the cover is detachably engaged with the front-end surface of the plug, so that the cover covers the front ends of the pin holes. In this way, when wires of a networking cable pass through the pin holes, front ends of the wires are not exposed, so that current leakage and malfunction of the wires due to environmental exposure could be prevented, thereby ensuring the signal transmission performance of the networking cable disposed in the networking cable connector structure.

Moreover, the diameter at the narrowest portion of the conical portion is less than the diameter of each of the insertion holes, so that when a user engages the cover with the plug, the insertion rods could be easily inserted into the insertion holes of the plug, and the entire insertion rods could be smoothly fixed within the insertion holes through press-fit engagement, thereby stably fixing the cover to the front-end surface of the plug.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the networking cable connector structure according to an embodiment of the present invention;

FIG. 2 is an exploded view of the networking cable connector structure according to the embodiment of the present invention;

FIG. 3 is a side view of the plug in FIG. 1;

FIG. 4 is a sectional view along the 4-4 line in FIG. 3;

FIG. 5 is a top view of the networking cable connector structure in FIG. 1;

FIG. 6 is a sectional view along the 6-6 line in FIG. 5;

FIG. 7 is a side view of the cover in FIG. 1;

FIG. 8 is a top view of the cover in FIG. 1;

FIG. 9 is a rear view of the cover in FIG. 1;

FIG. 10 is a schematic view showing that the networking cable connector structure according to the embodiment of the present invention is about to engage with the networking cable;

FIG. 11 is a sectional schematic view showing that the networking cable connector structure according to the embodiment of the present invention is engaged with the networking cable; and

FIG. 11A is an enlarged view of the marked region 11A in FIG. 11.

### DETAILED DESCRIPTION OF THE INVENTION

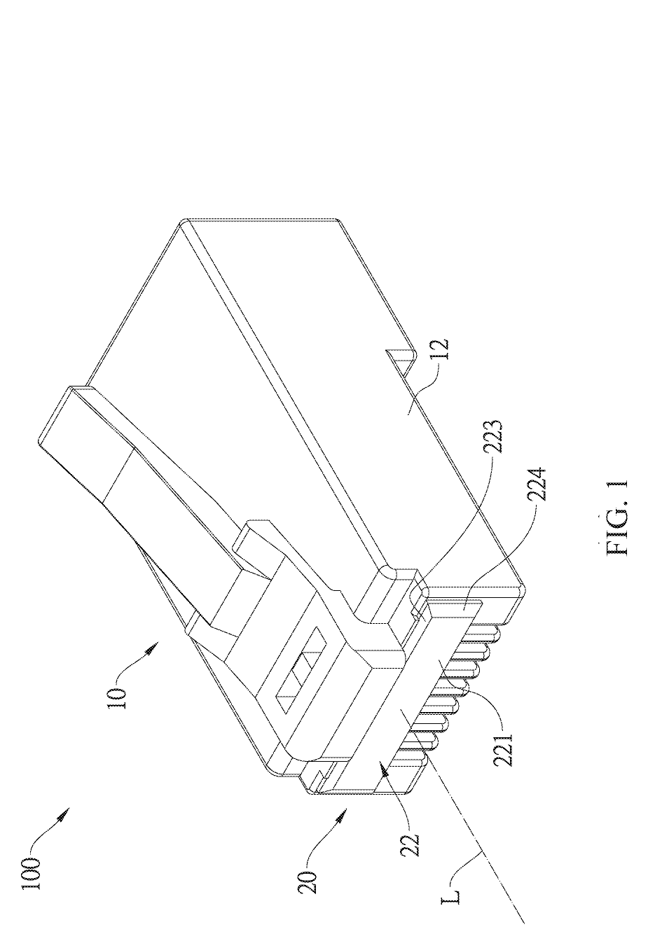

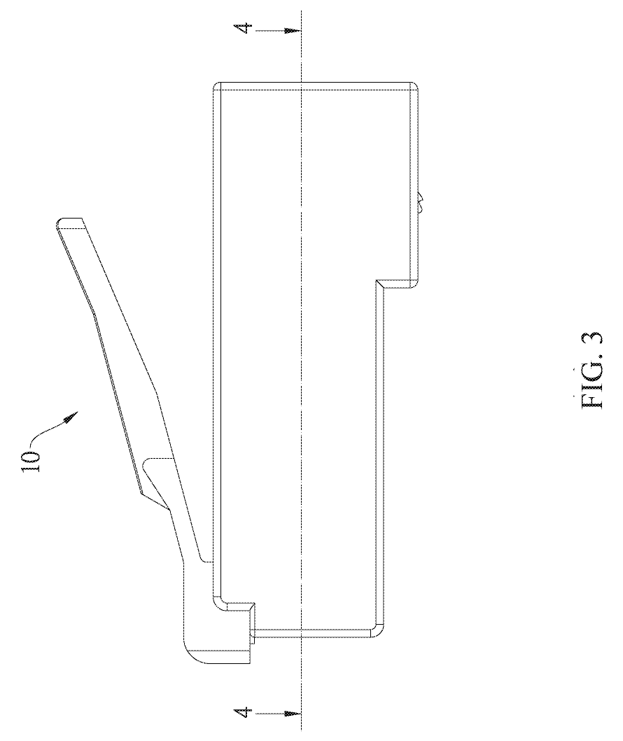

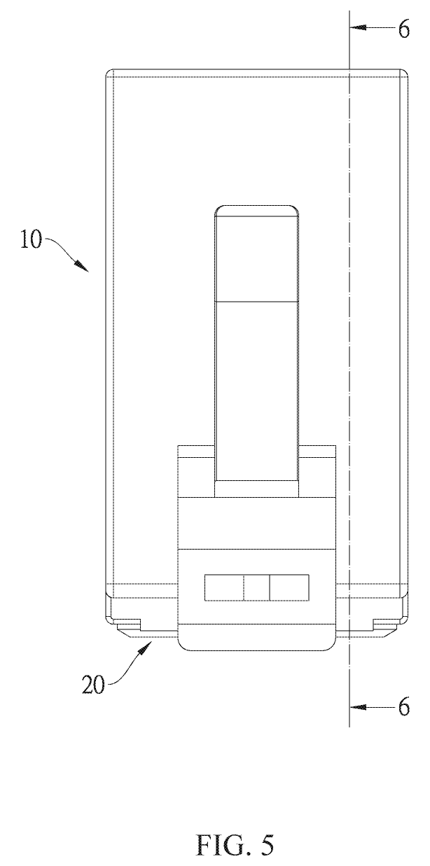

A networking cable connector structure 100 according to an embodiment of the present invention is illustrated in FIGS. 1-6 and includes a plug 10 and a cover 20. The cover 20 is engaged with the plug 10 along a front-rear direction L. In the current embodiment, the plug 10 could be a transparent plastic structure; the cover 20 could be a transparent plastic structure or a colored plastic structure, depending on different labeling requirements.

The plug 10 includes a main body 12 and a plurality of contacts 14. Two opposite ends of the main body 12 in the front-rear direction L are respectively provided with a front-end surface 121 and a rear-end surface 122. Two insertion holes 123 are respectively provided on a left side and a right side of the front-end surface 121. In the current embodiment, a length H of each of the insertion holes 123 in the front-rear direction L is greater than or equal to 2.0 mm; a diameter D of each of the insertion holes 123 is between 1.05 mm and 1.08 mm. A portion of the front-end surface 121 located between the two insertion holes 123 is provided with a plurality of pin holes 124 extending along the front-rear direction L. In the current embodiment, the plurality of pin holes 124 include eight pin holes 124. The pin holes 124 are horizontally arranged, and middle portions of any two adjacent pin holes 124 are connected to each other.

A front-end portion 121A is formed at a portion of the main body 12 adjacent to the front-end surface 121. A bottom side of the front-end portion 121A is provided with a plurality of grooves 125, wherein a number of the grooves 125 is equal to the number of the pin holes 124. A top end of each of the grooves 125 communicates with one of the pin holes 124. More specifically, each of the grooves 125 has a groove portion 1251 with an opening facing frontward and downward, each of the grooves 125 has a through hole 1252 connected between the groove portion 1251 and the pin hole 124 located above the groove portion 1251. A top side of the front-end portion 121A is connected to a locking tab 126. The locking tab 126 is configured to fix the plug 10 to a proper position. The rear-end surface 122 has a cable hole 127. The cable hole 127 is a hole extending along the front-rear direction L. A space of a front end of the cable hole 127 gradually decreases from rear to front, and the front end of the cable hole 127 communicates with rear ends of the pin holes 124.

A number of the contacts 14 is equal to the number of the pin holes 124 and the number of the grooves 125. The contacts 14 respectively pass through the grooves 125. More specifically, each of the contacts 14 is a metal piece ad has a contact portion 141 and a pronged portion 142 connected to the contact portion 141. The contact portion 141 of each of the contacts 14 is located in the groove portion 1251 of one of the grooves 125. The pronged portion 142 of each of the contacts 14 passes through the groove portion 1251 of one of the grooves 125.

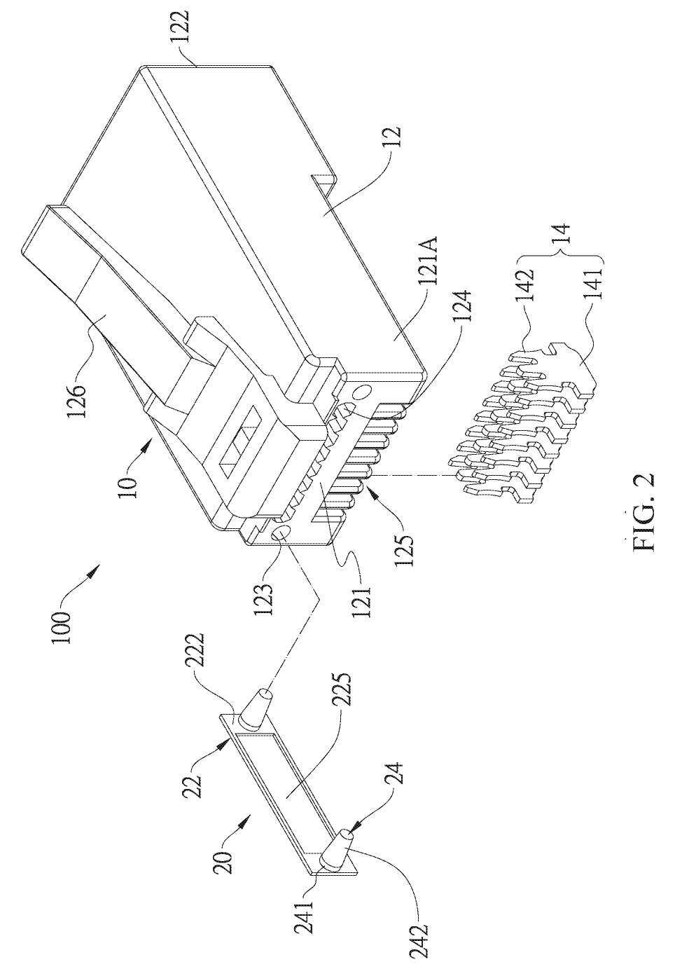

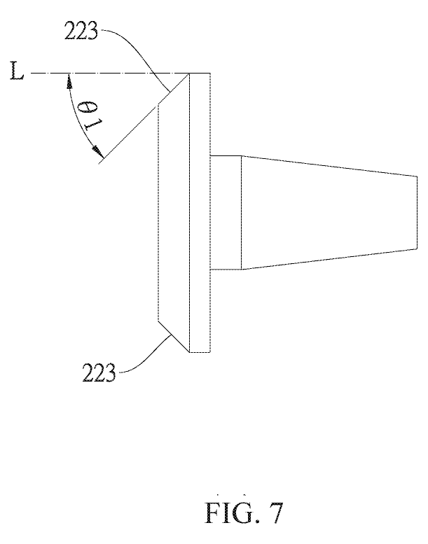

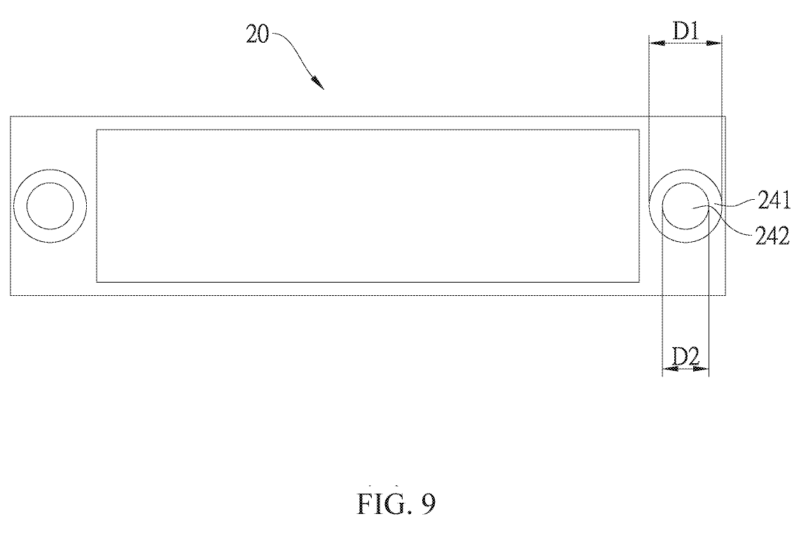

Referring to FIG. 1, FIGS. 2, and 7-9, the cover 20 includes a covering plate 22 and two insertion rods 24. The covering plate 22 is a rectangular plate and has a top edge, a bottom edge, a left edge, and a right edge. A side of the covering plate 22 facing away from the plug 10 has a front surface 221 and another side of the covering plate 22 facing the plug 10 has a rear surface 222. Two first inclined surfaces 223 are respectively formed on a portion of the front surface 221 adjacently connected to the top edge of the covering plate 22 and another portion of the front surface 221 adjacently connected to the bottom edge of the covering plate 22. An angle θ1 between each of the first inclined surfaces 223 and the front-rear direction L is 45°. Two second inclined surfaces 224 are respectively formed on still another portion of the front surface 221 adjacently connected to the left edge of the covering plate 22 and still another portion of the front surface 221 adjacently connected to the right side of the covering plate 22. An angle θ2 between each of the second inclined surfaces 224 and the front-rear direction L is 60°. The first inclined surfaces 223 and the second inclined surfaces 224 are tilted, so that the physical appearance could be improved and the covering plate 22 is unlikely to be detached from the plug 10 when the edges of the covering plate 22 are subjected to external collisions. The rear surface 222 is configured to abut against the front-end surface 121 of the plug 10, so that the covering plate 22 could cover front ends of the pin holes 124.

The two insertion rods 24 are respectively connected to a left side and a right side of the rear surface 222. A recess 225 is formed at a portion of the rear surface 222 located between the two insertion rods 24. The recess 225 is a rectangular groove and is configured to cover the front ends of the pin holes 124. Each of the insertion rods 24 is a rod body extending along the front-rear direction L and includes a base portion 241 and a conical portion 242 that are connected in sequence. The base portion 241 is a cylindrical body and is connected to the rear surface 222 of the covering plate 22. The base portion 241 is connected to the widest portion the conical portion 242 and a diameter of the base portion 241 at a connection between the base portion 241 and the conical portion 242 is equal to a diameter of the widest portion of the conical portion 242. An end of the conical portion 242 of each of the insertion rods 24 having the least diameter faces one of the insertion holes 123.

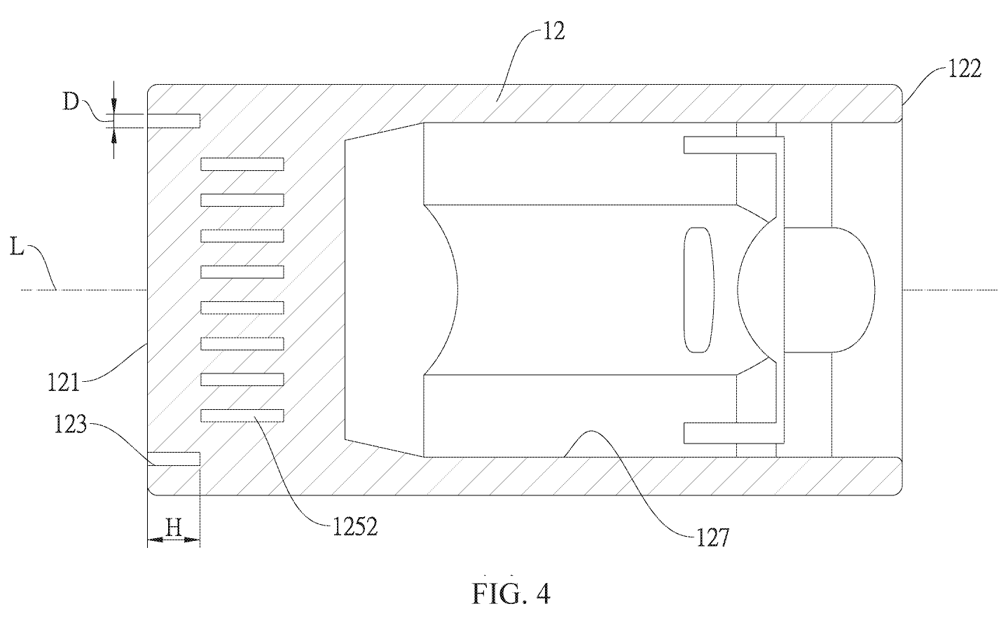

More specifically, referring to FIGS. 4 and 7-9, a length H1 of the base portion 241 of each of the insertion rods 24 along the front-rear direction L is 0.3 mm; a length H2 of the conical portion 242 of each of the insertion rods 24 along the front-rear direction L is 1.7 mm; a length H3 of each of the insertion rods 24 along the front-rear direction L is 2 mm. In this way, when each of the insertion rods 24 is inserted into one of the insertion holes 123, each of the insertion rods 24 with the length H3 could be received in one of the insertion holes 123 along the front-rear direction L. A dimeter D1 of each of the base portions 241 is 1.1 mm. A diameter D2 of the end of each of the conical portions 242 facing one of the insertion holes 123 is 0.7 mm. In this way, the diameter D2 of the narrowest portion of each of the insertion rods 24 is less than the diameter D of each of the insertion holes 123. At the same time, the greatest diameter of each of the insertion rods 24, i.e., the diameter D1 of each of the base portions 241, is slightly greater than the diameter D of each of the insertion holes 123. Preferably, a difference between the diameter D1 of each of the base portions 241 and the diameter D of each of the insertion holes 123 is between 0.02 mm and 0.05 mm.

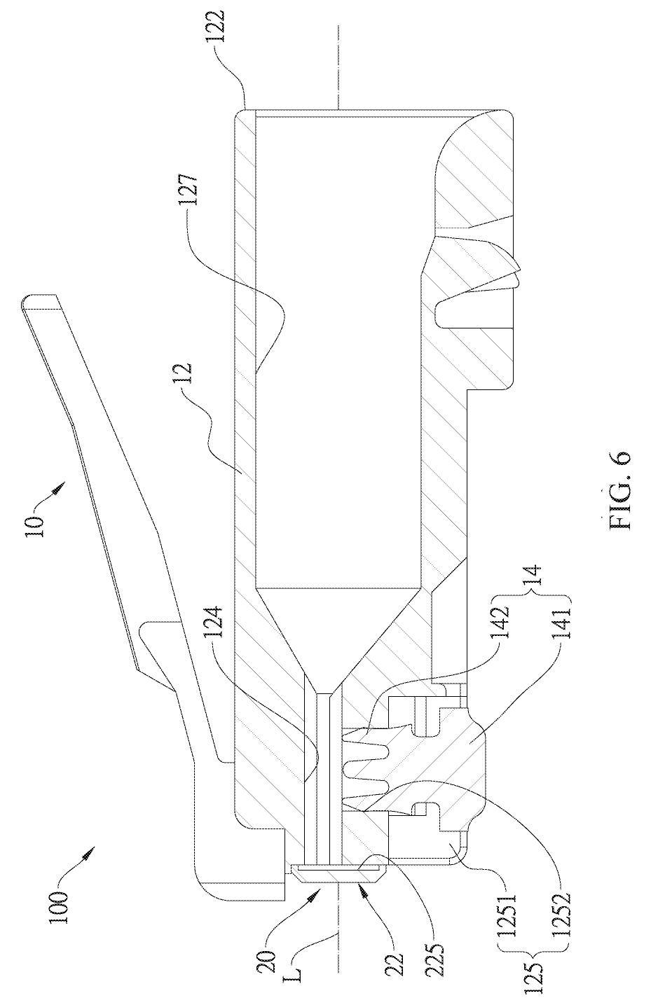

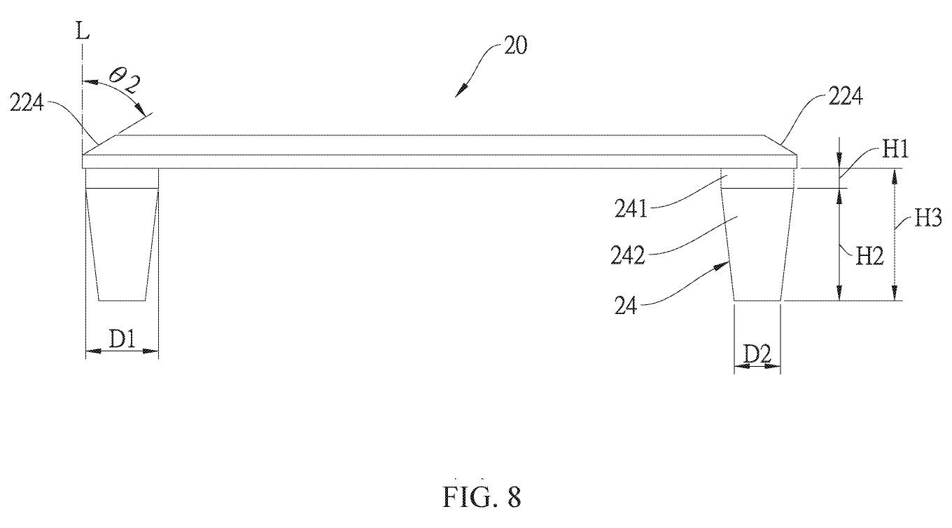

Referring to FIGS. 4 and 8, in this way, when a user inserts each of the insertion rods 24 of the cover 20 into one of the insertion holes 123, an end of each of the insertion rods 24 having the conical portion 242 could be easily inserted into one of the insertion holes 123 of the plug 10, and each of the insertion rods 24 could be smoothly inserted into one of the insertion holes 123 with the guidance of the corresponding conical portion 242. The plug 10 and the cover 20 are respectively plastic structures that are elastic and deformable and the diameter D1 of each of the base portions 241 is slightly greater than the diameter D of each of the insertion holes 123, so that when each of the base portions 241 is inserted into one of the insertion holes 123, each of the base portions 241 is fixed within one of the insertion holes 123 by press-fit engagement through deformation of one of the insertion holes 123. Referring to FIGS. 2 and 6, in this way, the cover 20 could be stably fixed to the front-end surface 121 of the plug 10, and the covering plate 22 covers the front ends of the pin holes 124.

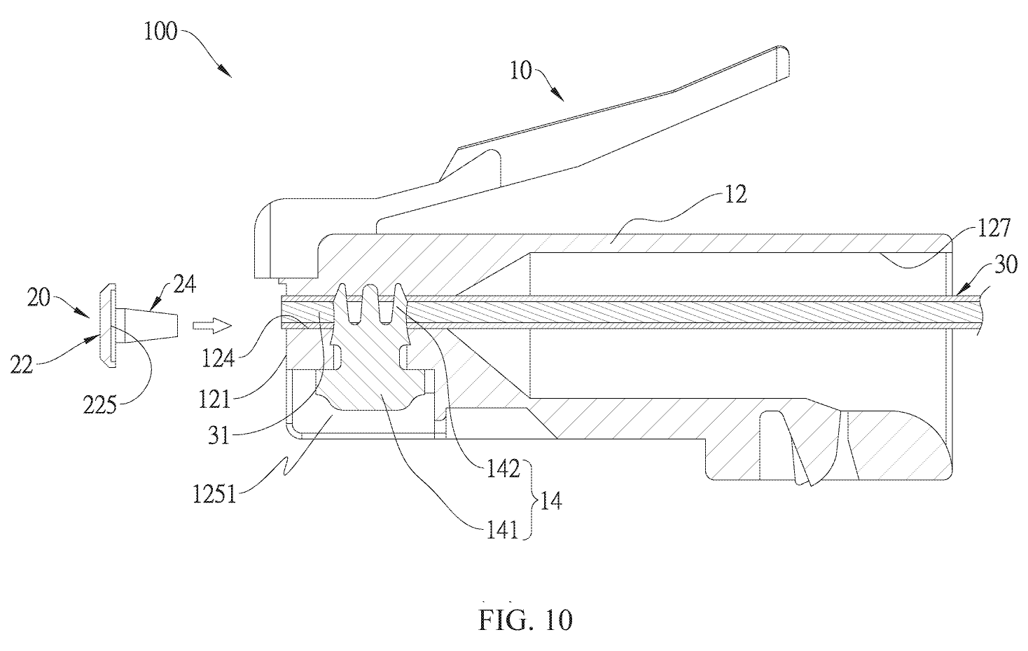

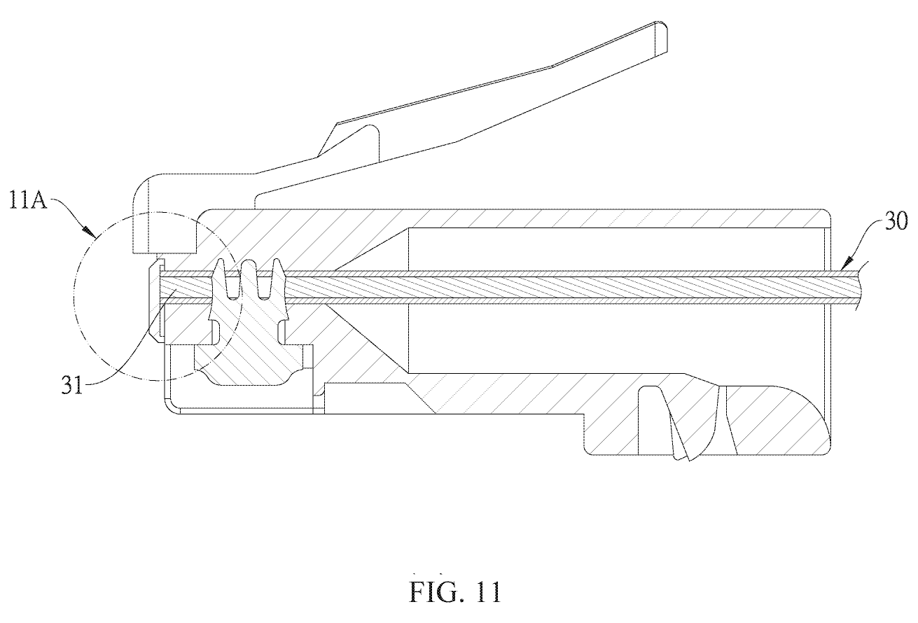

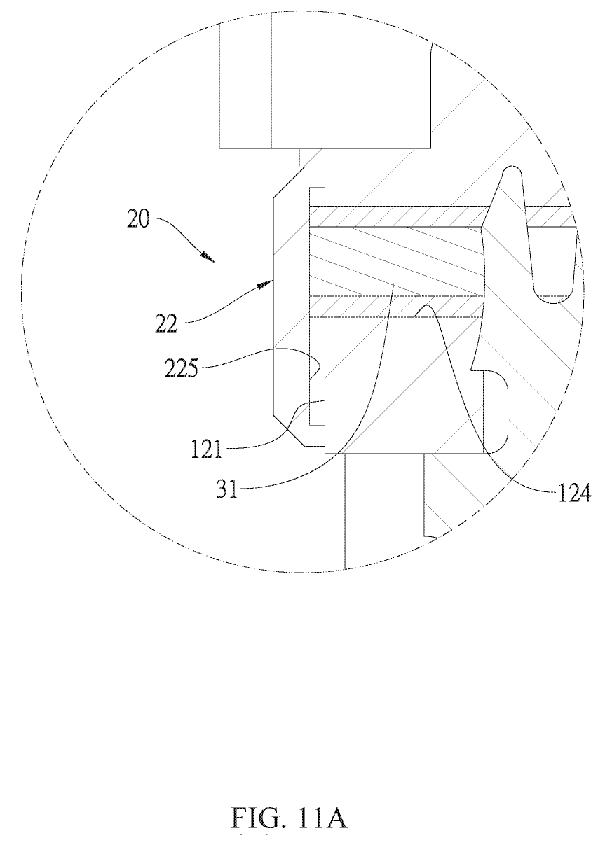

Referring to FIGS. 2 and 10-11A, when a networking cable 30 is disposed in the networking cable connector structure 100, the cover 20 and the plug 10 are separate. A plurality of wires 31 of the networking cable 30 is inserted through the cable hole 127 into the main body 12. The wires 31 pass through the pin holes 124. The contacts 14 are pushed into the pin holes 124 by using a crimping tool, so that the pronged portion 142 of each of the contacts 14 penetrates one of the wires 31 to be electrically connected to one of the wires 31. At that time, the contact portion 141 of each of the contacts 14 is moved to a top side of the groove portion 1251 of one of the grooves 125.

Afterwards, excessive portions of the wires 31 extending out of the pin holes 124 are cut by using a wire stripper. Finally, the two insertion rods 24 of the cover 20 are respectively inserted into the two insertion holes 123 of the plug 10, so that the cover 20 is engaged with the front-end surface 121 of the plug 10. The covering plate 22 covers front ends of the wires 31, and the recess 225 receives portions of the wires 31 extending out of the front-end surface 121. In this way, the front ends of the wires 31 are not exposed, so that electric leakage or malfunction of the wires 31 due to environmental exposure could be prevented, thereby ensuring the signal transmission performance of the networking cable 30 disposed in the networking cable connector structure 100.

It must be pointed out that the embodiment described above is only a preferred embodiment of the present invention. All equivalent structures which employ the concepts disclosed in this specification and the appended claims should fall within the scope of the present invention.

What is claimed is:

1. A networking cable connector structure, comprising:
a plug, comprising a main body, wherein the main body has a front-end surface and a rear-end surface; two insertion holes are respectively provided on two sides of the front-end surface; a plurality of pin holes extending along a front-rear direction is provided at a portion of the front-end surface located between the two insertion holes; the plurality of pin holes are horizontally arranged and middle portions of any two adjacent pin holes are connected to each other; the rear-end surface has a cable hole; a front end of the cable hole communicates with rear ends of the plurality of pin holes; a front-end portion is formed at a portion of the main body adjacently connected to the front-end surface; a bottom side of the front-end portion is provided with a plurality of grooves and a number of the plurality of grooves is equal to a number of the plurality of pin holes; a top end of each of the plurality of grooves communicates with one of the plurality of pin holes; a top side of the front-end portion is connected to a locking tab; and
a cover, having a covering plate, wherein a side of the covering plate facing the plug has a rear surface; two insertion rods are respectively connected to two sides of the rear surface; each of the two insertion rods has a conical portion; a diameter of the narrowest portion of the conical portion is less than a diameter of each of the two insertion holes; each of the two insertion rods is inserted into one of the two insertion holes through the conical portion of each of the two insertion rods, so that each of the two insertion rods is fixed within one of the two insertion holes through press-fit engagement; the covering plate covers front ends of the plurality of pin holes.

2. The networking cable connector structure as claimed in claim 1, wherein the plug and the cover are plastic structures; a diameter of the widest portion of each of the two insertion rods is slightly greater than the diameter of each of the two insertion holes.

3. The networking cable connector structure as claimed in claim 1, wherein a portion of each of the two insertion rods adjacently connected to the rear surface forms a base portion; the base portion is a cylindrical body and is connected to the widest portion of the conical portion; the base portion of each of the two insertion rods is inserted into and fixed within one of the two insertion holes through press-fit engagement.

4. The networking cable connector structure as claimed in claim 3, wherein a diameter of the base portion is 1.1 mm; a diameter of the widest portion of the conical portion is 1.1 mm; a diameter of an end of the conical portion of each of the two insertion rods facing one of the two insertion holes is 0.7 mm.

5. The networking cable connector structure as claimed in claim 3, wherein a length of the base portion along the front-rear direction is 0.3 mm; a length of the conical portion along the front-rear direction is 1.7 mm; a length of each of the two insertion holes along the front-rear direction is greater than or equal to 2.0 mm.

6. The networking cable connector structure as claimed in claim 1, wherein a recess is formed at a portion of the rear surface located between the two insertion rods; the recess covers the front ends of the plurality of pin holes.

7. The networking cable connector structure as claimed in claim 1, wherein another side of the covering plate away from the plug has a front surface; the covering plate is a rectangular plate and has a top edge, a bottom edge, a left edge, and a right edge; two first inclined surfaces are respectively formed on a portion of the front surface adjacently connected to the top edge of the covering plate and another portion of the front surface adjacently connected to the bottom edge of the covering plate; an angle between each of the two first inclined surfaces and the front-rear direction is 45°; two second inclined surfaces are respectively formed on still another portion of the front surface adjacently connected to the left edge of the covering plate and still another portion of the front surface adjacently connected to the right edge of the covering plate; an angle between each of the two second inclined surfaces and the front-rear direction is 60°.
